(19) United States
(12) Patent Application Publication
(10) Pub. No.: US 2026/0244768 A1
(43) Pub. Date: Aug. 20, 2026

(54) Optimized Cloud-Based Data Loss Prevention (DLP)

(71) Applicant: Zscaler, Inc., San Jose, CA (US)

(72) Inventors: Michael Schneider, Paderborn (DE); Peter Szabo, Dublin (IE)

(73) Assignee: Zscaler, Inc., San Jose, CA (US)

(21) Appl. No.: 19/055,016

(22) Filed: Feb. 17, 2025

(51) Int. Cl. G06F 21/60; G06F 21/54; G06F 21/62

(52) U.S. Cl. CPC G06F 21/604; G06F 21/54; G06F 21/6209

(57) ABSTRACT

Systems and methods for optimized cloud-based Data Loss Prevention (DLP) include monitoring user traffic associated with one or more tenants of the cloud-based system, the traffic including actions performed in association with a file sharing and storage service; responsive to a user accessing a file within the file sharing and storage service, performing a DLP scan requirement analysis; based on a result of the DLP scan requirement analysis, (i) performing a DLP scan of the file or (ii) bypassing a DLP scan of the file; and performing one or more actions based on policy associated with the user and the file.

### FIELD OF THE DISCLOSURE

The present disclosure generally relates to network and cloud security. More particularly, the present disclosure relates to systems and methods for optimized cloud-based Data Loss Prevention (DLP)

### BACKGROUND OF THE DISCLOSURE

Data Loss Prevention (DLP) is a security strategy and technology designed to detect and prevent unauthorized access, sharing, or transmission of sensitive data. By monitoring and controlling data transfers across networks, endpoints, and cloud services, DLP ensures compliance with regulatory requirements and protects critical information like intellectual property, personally identifiable information (PII), and financial data. However, traditional DLP solutions can significantly slow down the user experience due to their resource-intensive inspection processes. Inline traffic analysis, especially in encrypted channels, often introduces latency, delays uploads or downloads, and disrupts workflows, particularly in environments with high data volumes or complex rule sets. This performance trade-off can frustrate users and impact productivity, underscoring the need for more efficient DLP solutions.

### BRIEF SUMMARY OF THE DISCLOSURE

The present disclosure relates to systems and methods for optimized cloud-based DLP. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring user traffic associated with one or more tenants of the cloud-based system, the traffic including actions performed in association with a file sharing and storage service; responsive to a user accessing a file within the file sharing and storage service, performing a Data Loss Prevention (DLP) scan requirement analysis; based on a result of the DLP scan requirement analysis, (i) performing a DLP scan of the file or (ii) bypassing a DLP scan of the file; and performing one or more actions based on policy associated with the user and the file.

The steps can further include wherein the DLP scan requirement analysis is based on stored file metadata and the action performed by the user on the file. The DLP scan requirement analysis can be based on stored file metadata, the file metadata including any of a hash of the file, a name of the file, an owner of the file, a label of the file, a classification of the file, dictionaries of the file, a policy time stamp, and file sharing information. A DLP scan can be performed on the file responsive to determining that the file has been changed. A DLP scan can be performed on the file responsive to determining that policy associated with the file has been changed. A DLP scan can be performed on the file responsive to determining that an owner of the file has changed. A DLP scan can be performed on the file responsive to determining that file sharing information of the file has changed. Responsive to the user creating a new file in the file sharing and storage service, the steps can include performing a DLP scan of the file; and storing original metadata of the file. The DLP scan requirement analysis can be based on original metadata of the file and current metadata of the file. The one or more actions can be performed based on the DLP scan of the file.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a traditional process for performing DLP during initial file creation and subsequent file changes.

FIG. 6 is a flow diagram of an optimized process for performing DLP during initial file creation.

FIG. 7 is a flow diagram of an optimized process for performing DLP in response to a file change, where a DLP scan is needed.

FIG. 8 is a flow diagram of an optimized process for performing DLP in response to a file change, where a DLP scan is not needed.

FIG. 9 is a diagram of a data lifecycle that can be displayed within a dashboard of the cloud.

FIG. 10 is a flowchart of a process for optimized cloud-based DLP.

### DETAILED DESCRIPTION OF THE DISCLOSURE

Again, the present disclosure relates to systems and methods for optimized cloud-based Data Loss Prevention (DLP). The present DLP process represents a significant evolution in data security, leveraging advanced cloud-based technologies to provide rapid and efficient protection of sensitive information. Traditionally, DLP solutions have faced challenges with latency and resource consumption due to extensive data scanning requirements. However, the present approach optimizes the DLP process by integrating intelligent metadata analysis and real-time user activity monitoring. By storing and correlating detailed metadata about files and their interactions within the system, the optimized cloud-based DLP process minimizes the need for repetitive and time-consuming scans. This innovative method allows for swift detection and response to potential data breaches or policy violations, ensuring robust data security without compromising on performance. As a result, cloud tenants benefit from enhanced visibility and control over their data, significantly reducing the risk of data loss while optimizing operational efficiency and reducing overall costs.

### § 1.0 Cybersecurity Monitoring and Protection Examples

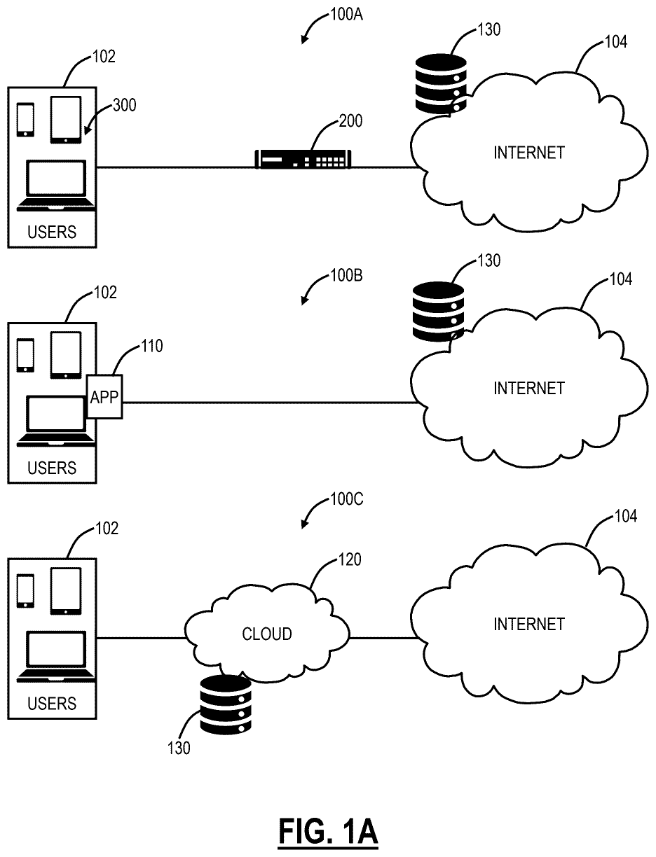

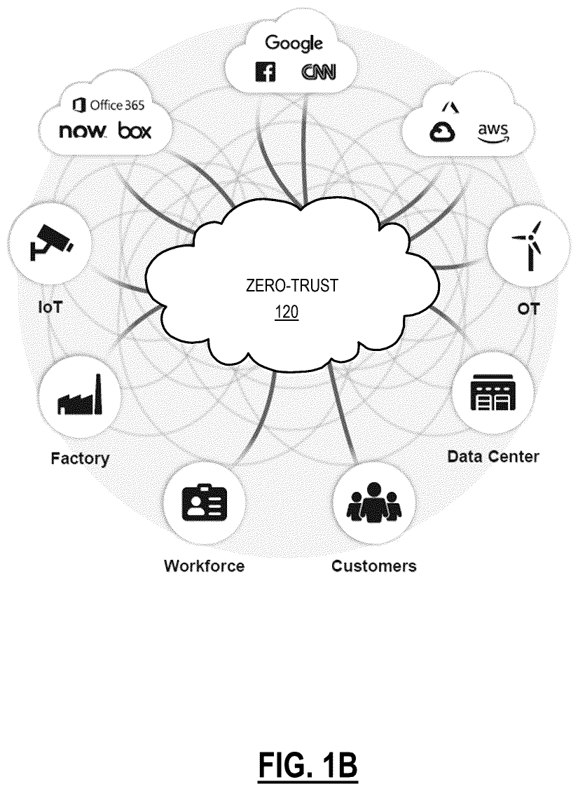

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

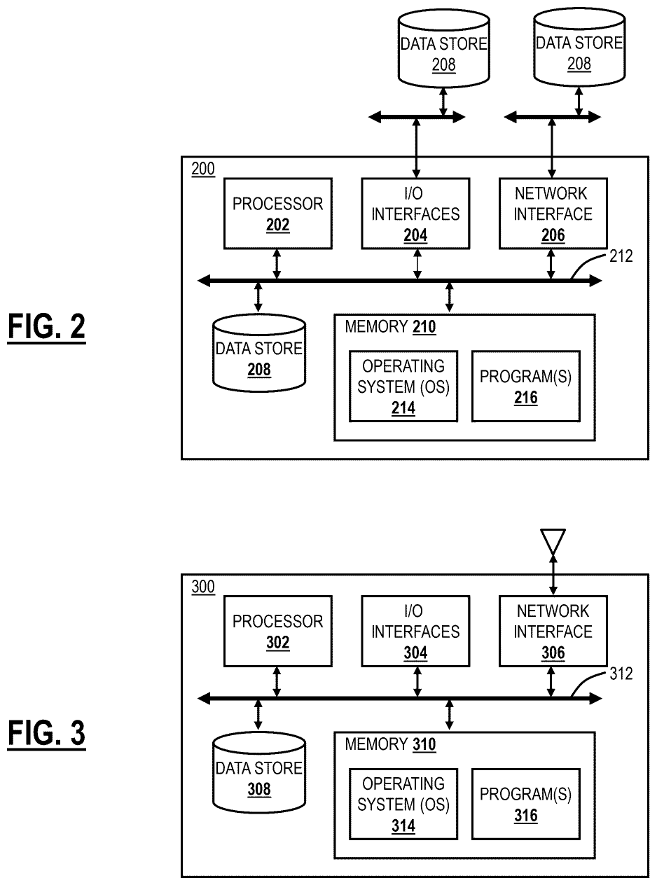

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

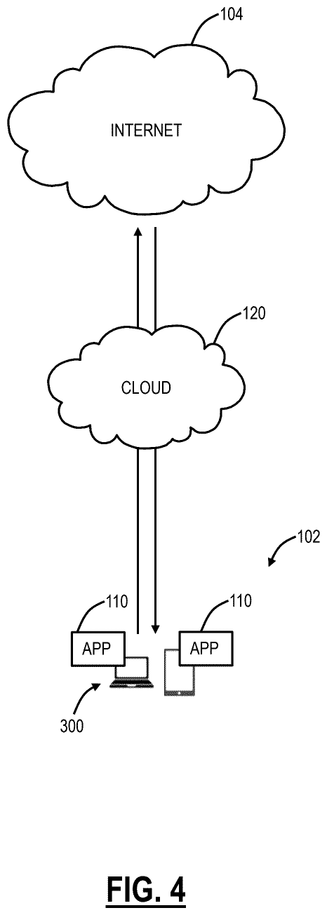

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Cloud-based Dlp

The present cloud 120 (i.e., the cloud-based system) provides a robust Data Loss Prevention (DLP) solution designed to protect sensitive data for its tenants across diverse environments. As a fully cloud-native solution, the cloud 120 enables inline inspection of all user traffic—whether originating from branch offices, headquarters, or remote workers—by routing it through its globally distributed cloud infrastructure. This approach ensures real-time inspection of web, email, SaaS, and custom enterprise application traffic for potential data leakage, regardless of user location. Administrators can define granular, policy-based controls tailored to their organization's data protection requirements, including blocking, alerting, or quarantining attempts to share sensitive data such as personally identifiable information (PII), credit card numbers, or intellectual property. The cloud 120 also supports compliance with industry standards such as General Data Protection Regulation (GDPR), Health Insurance Portability and Accountability Act (HIPAA), and Payment Card Industry Data Security Standard (PCI DSS) by applying consistent policies across users, devices, and locations.

The cloud 120 employs advanced data inspection techniques such as file fingerprinting, keyword matching, regular expressions, and machine learning-based classification to identify and protect sensitive data. It ensures effective DLP enforcement even in encrypted sessions through SSL/TLS inspection within its secure cloud infrastructure. The cloud 120 integrates with threat intelligence feeds to detect potential risks such as insider threats and anomalous user behavior, triggering appropriate actions to prevent data exfiltration. Built on zero trust principles, the DLP solution ensures that data access is strictly based on user identity, device posture, and contextual factors, eliminating implicit trust and reducing the risk of unauthorized data exposure.

By routing all user traffic through its Secure Internet Access (ZIA) and Private Access (ZPA) solutions, the cloud 120 ensures full visibility into data in transit. Real-time inspection, combined with flexible enforcement options, enables blocking untrusted uploads, masking sensitive information in logs, or generating alerts for administrators to review. Incidents are logged in admin portal of each tenant, where detailed reports provide actionable insights into DLP violations, facilitating compliance and audit readiness. The platform's machine learning capabilities enhance accuracy in identifying sensitive data, reducing false positives and improving overall efficiency. Its centralized management console simplifies policy creation, enforcement, and reporting, making it user-friendly and scalable to growing traffic volumes.

The cloud 120 DLP solution is especially suited for hybrid and remote work environments, offering consistent protection across all users and locations. It integrates seamlessly with the Zero Trust Exchange (ZTE), ensuring data security within the broader zero trust architecture. By continuously innovating and delivering seamless updates, the cloud 120 provides its tenants with cutting-edge DLP technologies and threat intelligence, empowering organizations to safeguard their sensitive data in an ever-evolving threat landscape.

### § 6.0 Cloud Access Security Broker (CASB)

A Cloud Access Security Broker (CASB) is a security solution that acts as an intermediary between users and cloud service providers, enforcing security policies and ensuring compliance when accessing cloud-based resources. The cloud 120 implements CASB systems, designed to help organizations securely adopt and manage multiple Software as a Service (SaaS) applications. It offers both inline and out-of-band security capabilities to protect data, prevent threats, and ensure compliance across SaaS and Infrastructure as a Service (IaaS) platforms.

CASBs have progressively transformed into a more comprehensive category known as Secure Access Service Edge (SASE). SASE represents a network architecture that integrates Wide-Area Networking (WAN) and extensive security functions into a single, cohesive cloud-based service model.

The evolution from CASB to SASE marks a significant advancement in the realm of network security and management. Initially, CASBs were primarily focused on delivering security and policy enforcement for accessing cloud services. However, as the demand for more integrated and comprehensive security solutions increased, the SASE framework emerged. SASE incorporates the core functionalities of CASB with additional critical security services, including Secure Web Gateways (SWG), Zero Trust Network Access (ZTNA), and Firewall-as-a-Service (FWaaS).

One of the key features of SASE is its unified management approach. SASE provides a single, consolidated management interface that simplifies the administration and enforcement of security policies across an enterprise network. This unified approach is particularly beneficial for organizations managing complex and hybrid environments.

Moreover, SASE is designed as a cloud-native architecture, offering unparalleled scalability, flexibility, and ease of deployment compared to traditional on-premises solutions. This design aligns perfectly with the increasingly cloud-centric IT infrastructures of modern organizations. By leveraging a global network of Points of Presence (PoPs), SASE solutions ensure low-latency, high-performance access to cloud services and applications, regardless of user location.

Key components of SASE include:

CASB: Provides visibility, compliance, data security, and threat protection for cloud services.

SWG: Protects users from web-based threats by filtering and monitoring web traffic.

ZTNA: Ensures secure access to applications based on identity and context, rather than just network location.

FWaaS: Delivers firewall capabilities as a cloud service, providing network security and traffic inspection.

Software-Defined Wide Area Networking (SD-WAN): Enhances network performance and reliability by dynamically routing traffic across the most efficient path.

The benefits of adopting SASE are numerous. Enhanced security is achieved through the integration of multiple security functions, providing comprehensive protection against a wide range of threats. Simplified management through a unified platform reduces complexity and administrative overhead, ensuring consistent security policy enforcement. The cloud-native architecture of SASE allows organizations to effortlessly scale their security infrastructure as needs grow. Additionally, with a global network of PoPs, SASE solutions can optimize traffic routing, resulting in improved performance and user experience. Lastly, SASE is designed with future-proofing in mind, adapting to evolving security needs and technological advancements, thereby offering a forward-looking approach to enterprise security.

### § 7.0 Optimized Cloud-Based DLP

The present disclosure introduces an innovative approach designed to offer increased insights into a data-protection, data-driven ecosystem. This advanced method facilitates rapid policy decision-making, significantly reducing the need for extensive data scanning. Additionally, it adeptly correlates user events, providing a comprehensive understanding of data lineage. By integrating these capabilities, the system ensures a more efficient and insightful management of data protection, enhancing the overall effectiveness of the ecosystem in safeguarding sensitive information and optimizing operational processes.

Today, out-of-band CASBs integrate with SaaS applications through APIs. Data scans are conducted either according to a predetermined schedule or triggered by notifications from the applications themselves when file changes are detected. Furthermore, audit events—referred to as activities—such as user logins, file creations, file changes, and sharing actions, are reported back to the system. However, the extensive number of API queries required for these operations can heavily impact the customer's allotted API quota. For instance, a single file upload to SharePoint or OneDrive could generate up to eight API queries, thereby imposing a significant load on their API usage limits.

An organization can rapidly approach the limits of its API usage or encounter throttling issues due to the high volume of API queries. This challenge is not exclusive to any single cloud service but can be observed across various platforms. However, for the purposes of this disclosure, Microsoft services will be used as the primary example. The key focus areas addressed in this document include strategies for accelerating DLP processes while reducing the frequency of scans, yet still achieving the same high-quality results. This approach aims to optimize system efficiency and ensure that data protection measures remain robust without overburdening the API quotas.

As described herein, current systems gather multiple input feeds from platforms such as the Microsoft platforms described herein, encompassing details about file state changes, file creation, and other related activities. Moreover, these systems also monitor user activity, such as logins, file creation, sharing actions, etc. The present systems utilize a degree of overlap between them, as both streams often contain information about the same activities. By integrating these overlapping data streams and incorporating additional metadata, it is possible to develop a more efficient and resource-conserving DLP system. This integrated approach can streamline the DLP processes, reducing the need for repetitive scans and ultimately speeding up the system's performance while maintaining the same high level of data protection.

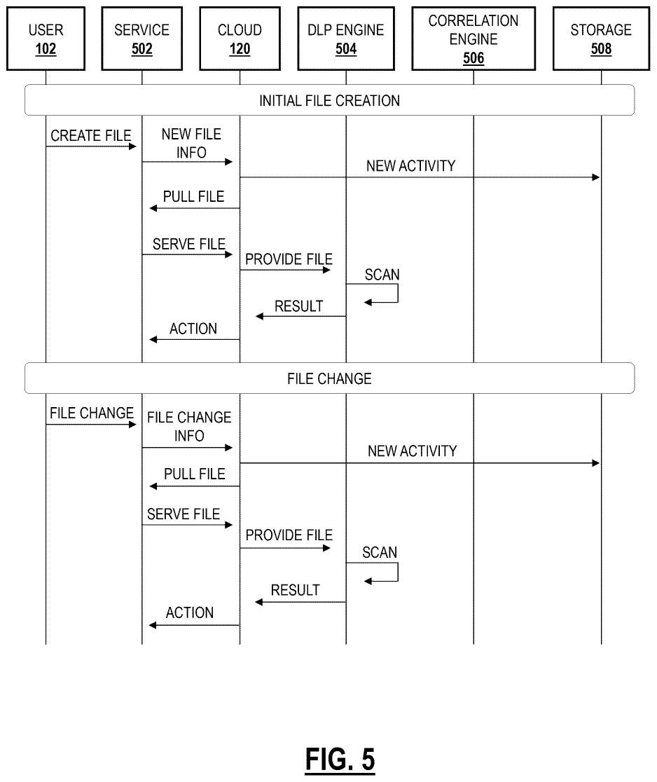

FIG. 5 is a flow diagram of a traditional process for performing DLP during initial file creation and subsequent file changes. In response to a user 102 creating a file, for example in Microsoft SharePoint, i.e., the service 502, the cloud 120 is adapted to collect the file info. From there, the cloud 120 can log the new activity in storage 508. After pulling the file from the service 502, the cloud 120 provides the file to a DLP engine 504, where the DLP engine 504 performs a scan of the file. Based thereon, the results of the scan are provided to the cloud 120, where the cloud 120 can perform an action as described herein. For example, the action can include blocking the file, deleting the file, allowing access to the file based on policy, etc.

In response to a user 102 performing a file change, the cloud 120 can again log the new activity in storage 508. Then, based on the user 102 performing the file change, the cloud 120 again causes the DLP engine 504 to perform a scan of the file. As can be seen, the traditional methods perform scans in response to any file change/activity and do not utilize any file or activity context to decide whether to perform the scan or not.

As illustrated in the accompanying figure, the interaction between SaaS services consistently follows a “notify->push->put” mechanism. This established pattern involves notifying the system of an event, pushing the relevant data, and then providing or storing the data accordingly. While this fundamental concept remains essential, there is significant potential for optimization to enhance efficiency and reduce unnecessary resource consumption.

One innovative approach to achieving this optimization involves the creation of a data lake that houses metadata about the files. By accumulating and managing metadata in this centralized repository, the system can correlate this information with user activity data. This correlation process enables the system to monitor and manage data transfers more effectively without the need for repeatedly scanning the actual files themselves. Instead, by leveraging the comprehensive metadata and user activity correlations, the system can promptly identify and address data protection concerns, thereby streamlining operations and conserving resources while maintaining robust data security.

Upon the initial pull and inspection of a file, various pieces of metadata—such as its hash, name, creation date, owner, sharing status, labels, and classification after scanning —are stored in a database. This metadata is carefully cataloged so that it can be easily retrieved at a later time. In this initial scanning process, no changes to the existing concept are made. However, when a file undergoes a change or activity, such as being shared, these modifications become immediately apparent.

If a file remains unchanged in terms of its hash or other similar attributes, and only an activity like sharing is performed, the system can respond directly to this activity without the need to rescan the file. This is because the file itself has not changed; only an action related to the file has occurred. By recognizing this, the system can bypass unnecessary rescanning, thereby enabling faster responses to state changes. This procedure significantly minimizes data transfer and reduces the volume of data exchanged between platforms.

Ultimately, this approach optimizes operational costs, lowers API quota usage, and reduces resource requirements in the cloud 120, ensuring a more efficient and cost-effective management of data protection activities.

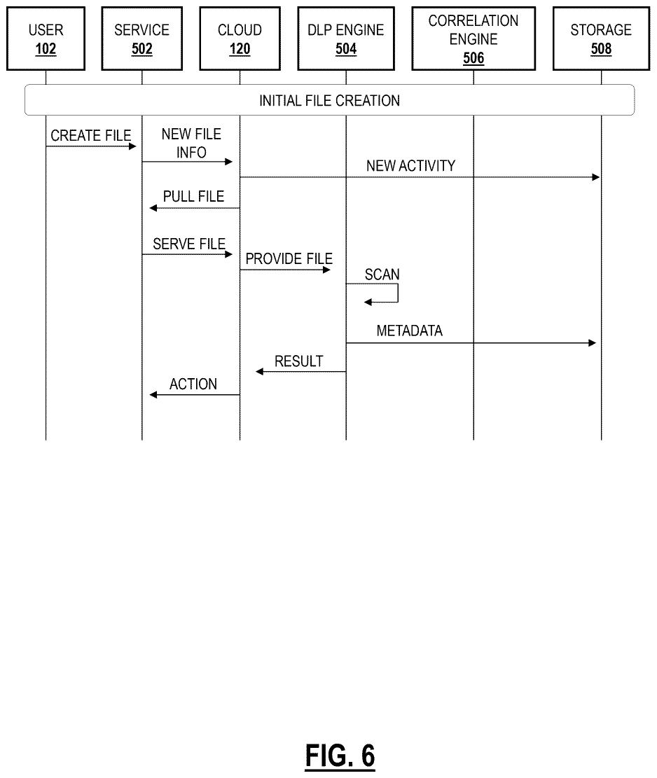

FIG. 6 is a flow diagram of an optimized process for performing DLP during initial file creation. In response to a user 102 creating a new file, for example in Microsoft SharePoint, i.e., the service 502, the cloud 120 is adapted to collect the file info from the service 502. This new activity is then logged in the storage 508. The storage 508 can also be contemplated as the log data 130 of the cloud 120 as described herein. from there, the cloud 120 provides the file to the DLP engine 504. The DLP engine is then adapted to perform a scan of the new file. This scan includes collecting metadata of the file, the metadata including a hash of the file, a name/file ID of the file, an owner of the file, a label of the file, a classification of the file, dictionaries of the file, a policy time stamp, file sharing information, etc. This metadata of the file is then also stored in the storage 508. Further, based on the scan, the results are forwarded from the DLP engine 504 to the cloud 120 for performing an action.

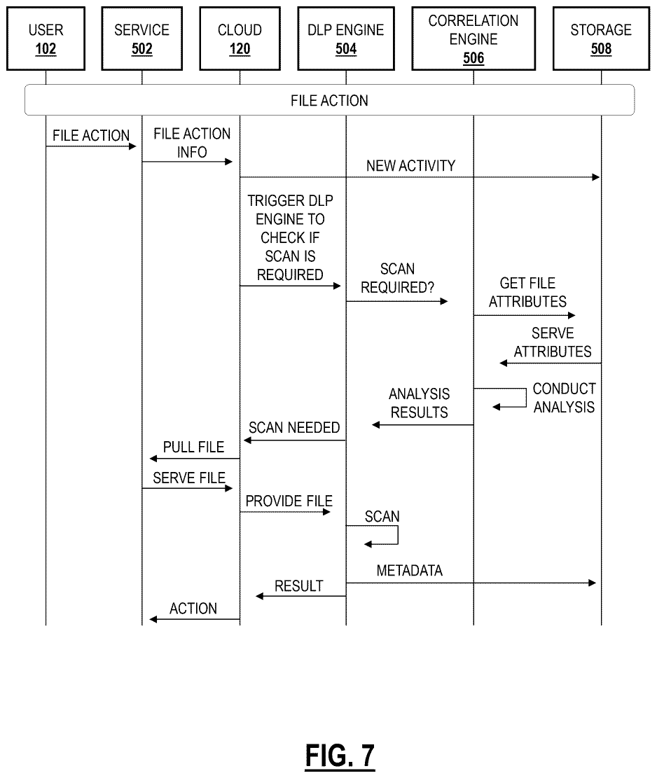

FIG. 7 is a flow diagram of an optimized process for performing DLP in response to a file change, where a DLP scan is needed. In response to a user 102 performing a file change to a file in the service 502, the cloud 120 is adapted to log the new activity in the storage 508. The cloud 120 is also adapted to, in response to the activity, cause the DLP engine 504 to determine if a scan is required. To do this, the DLP engine 504 triggers a correlation engine 506 to perform a scan requirement analysis. This scan requirement analysis process includes collecting file attributes, i.e., original or previously stored file metadata, from the storage 508. The correlation engine 506 then performs an analysis to determine if a scan is required based on the original or previously stored metadata the action performed by the user 102 and current metadata of the file. This analysis includes determining whether the DLP policy is the same as the file's entry policy, determining if there were any file hash changes, determining if the label is the same, determining if there are any sharing changes associated with the file, etc.

The analysis results are then forwarded to the DLP engine 504, where the DLP engine is adapted to, based on the correlation engine 506 determining that a scan is required, cause the cloud 120 to initiate the file scan. Determining that a file scan is required can be based on determining that the file has changed, policy has changed, label has changed, sharing has changed, etc.

The file scan again includes the cloud 120 providing the file to the DLP engine 504. The DLP engine is then adapted to perform a scan of the changed file. This scan again includes collecting metadata of the file and storing the metadata of the file in the storage 508. Based on the scan, the results are forwarded from the DLP engine 504 to the cloud 120 for performing an action. It will be appreciated that the DLP engine 504, correlation engine 506, and storage 508 are all components of the cloud 120. That is, the DLP processes described herein are cloud-based, meaning that the steps are performed in the cloud 120.

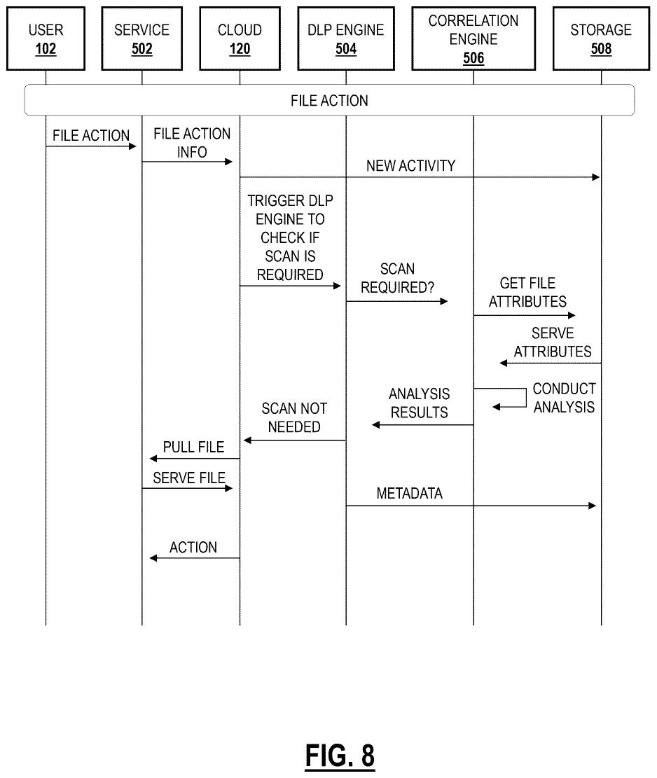

FIG. 8 is a flow diagram of an optimized process for performing DLP in response to a file change, where a DLP scan is not needed. In response to a user 102 performing an activity with the file in the service 502, the cloud 120 is adapted to log the new activity in the storage 508. The cloud 120 is also adapted to, in response to the activity, cause the DLP engine 504 to determine if a scan is required. To do this, the DLP engine 504 triggers the correlation engine 506 to perform the scan requirement analysis. This analysis again includes determining whether the DLP policy is the same as the file's entry policy, determining if there were any file hash changes, determining if the label is the same, determining if there are any sharing changes associated with the file, etc.

The analysis results are then forwarded to the DLP engine 504, where the DLP engine is adapted to, based on the correlation engine 506 determining that a scan is not required, inform the cloud 120 that a scan is not required. Determining that a file scan is not required can be based on determining that the file has not changed, policy has not changed, label has not changed, sharing has not changed, etc. Based thereon, the cloud 120 is adapted to update the files metadata in the storage 508 and perform an action.

It will be appreciated that the present example of the service 502 being Microsoft SharePoint is a non-limiting example. That is, the service 502 can be any file storage and sharing service/SaaS application accessible by users of the cloud 120. The cloud 120 is adapted to integrate with the service 502 in order to facilitate the steps of the optimized DLP process described herein.

The approach outlined above effectively demonstrates how the cloud 120 can build a comprehensive repository of file information. While the context provided focuses on out-of-band CASB, this concept is equally applicable to any domain where DLP is being implemented.

Expanding this approach to encompass any DLP enforcement point enables the creation of a seamlessly connected ecosystem. Within this ecosystem, the movement, creation, and traversal of files can be meticulously tracked, with all associated metadata universally accessible. This interconnected framework offers unparalleled visibility into a data-centric and integrated ecosystem, significantly enhancing our understanding of data lineage.

By leveraging this comprehensive visibility, organizations gain profound insights into their data, enabling them to implement innovative data security measures for their critical digital assets. This approach not only ensures robust data protection, but also fosters a fully connected, data-centric experience for customers, empowering them with the tools needed to safeguard their valuable information effectively.

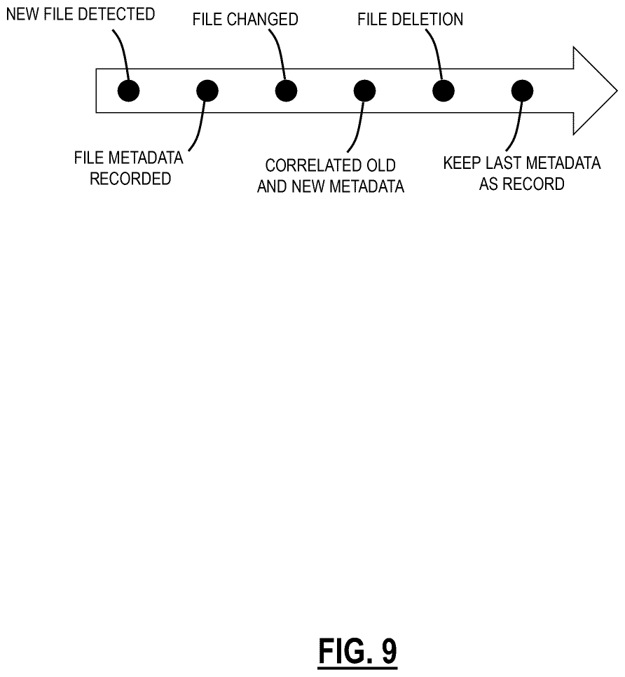

The data lifecycle can be effectively visualized through a comprehensive dashboard within the cloud-based system (the cloud 120). FIG. 9 is a diagram of a data lifecycle that can be displayed within a dashboard of the cloud 120. This dashboard provides a clear and intuitive interface, showcasing the entire journey of files within the ecosystem. It is adapted to display key metrics and insights, such as file creation dates, ownership details, sharing statuses, and any modifications or activities associated with each file.

By presenting this information in a centralized and easily accessible manner, the dashboard enables users/administrators to monitor and manage their data more efficiently. It highlights patterns and trends in file usage, reveals potential security threats, and tracks compliance with data protection policies. Users can quickly identify files that have been shared, modified, or accessed, and take appropriate actions to ensure data security.

Moreover, the dashboard offers advanced filtering and search capabilities, allowing users to drill down into specific details and generate customized reports. This level of visibility and control empowers organizations to make informed decisions, optimize their data protection strategies, and enhance their overall security posture. Ultimately, the dashboard serves as a powerful tool, providing a holistic view of the data lifecycle and facilitating a more proactive and effective approach to data management and security in the cloud.

### § 7.1 Optimized Cloud-based Dlp Process

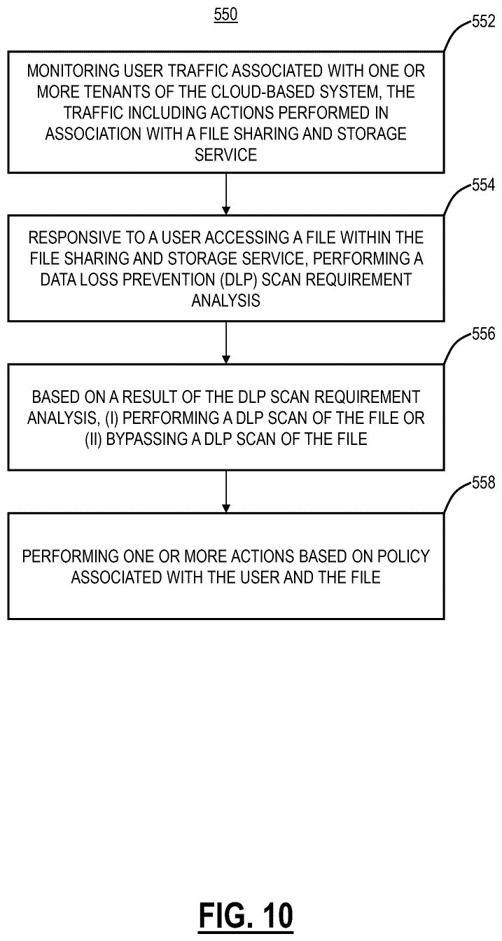

FIG. 10 is a flowchart of a process 550 for optimized cloud-based DLP. The process 550 can be contemplated as a method having steps, a processing device configured to implement the steps, a cloud-based system configured to implement the steps, and as a non-transitory computer-readable medium storing instructions for programming one or more processors to execute the steps. The process 550 includes monitoring user traffic associated with one or more tenants of the cloud-based system, the traffic including actions performed in association with a file sharing and storage service (step 552); responsive to a user accessing a file within the file sharing and storage service, performing a Data Loss Prevention (DLP) scan requirement analysis (step 554); based on a result of the DLP scan requirement analysis, (i) performing a DLP scan of the file or (ii) bypassing a DLP scan of the file (step 556); and performing one or more actions based on policy associated with the user and the file (step 558).

The process 550 can further include wherein the DLP scan requirement analysis is based on stored file metadata and the action performed by the user on the file. The DLP scan requirement analysis can be based on stored file metadata, the file metadata including any of a hash of the file, a name of the file, an owner of the file, a label of the file, a classification of the file, dictionaries of the file, a policy time stamp, and file sharing information. A DLP scan can be performed on the file responsive to determining that the file has been changed. A DLP scan can be performed on the file responsive to determining that policy associated with the file has been changed. A DLP scan can be performed on the file responsive to determining that an owner of the file has changed. A DLP scan can be performed on the file responsive to determining that file sharing information of the file has changed. Responsive to the user creating a new file in the file sharing and storage service, the steps can include performing a DLP scan of the file; and storing original metadata of the file. The DLP scan requirement analysis can be based on original metadata of the file and current metadata of the file. The one or more actions can be performed based on the DLP scan of the file.

### § 8.0 Processing Circuitry and Non-transitory Computer-readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 9.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method implemented by a cloud-based system, the method comprising steps of:
monitoring user traffic associated with one or more tenants of the cloud-based system, the traffic including actions performed in association with a file sharing and storage service;
responsive to a user accessing a file within the file sharing and storage service, performing a Data Loss Prevention (DLP) scan requirement analysis;
based on a result of the DLP scan requirement analysis, (i) performing a DLP scan of the file or (ii) bypassing a DLP scan of the file; and
performing one or more actions based on policy associated with the user and the file.

2. The method of claim 1, wherein the DLP scan requirement analysis is based on stored file metadata and the action performed by the user on the file.

3. The method of claim 1, wherein the DLP scan requirement analysis is based on stored file metadata, the file metadata including any of a hash of the file, a name of the file, an owner of the file, a label of the file, a classification of the file, dictionaries of the file, a policy time stamp, and file sharing information.

4. The method of claim 3, wherein a DLP scan is performed on the file responsive to determining that the file has been changed.

5. The method of claim 3, wherein a DLP scan is performed on the file responsive to determining that policy associated with the file has been changed.

6. The method of claim 3, wherein a DLP scan is performed on the file responsive to determining that an owner of the file has changed.

7. The method of claim 3, wherein a DLP scan is performed on the file responsive to determining that file sharing information of the file has changed.

8. The method of claim 1, wherein responsive to the user creating a new file in the file sharing and storage service, the steps comprise:
performing a DLP scan of the file; and
storing original metadata of the file.

9. The method of claim 8, wherein the DLP scan requirement analysis is based on the original metadata of the file and current metadata of the file.

10. The method of claim 1, wherein the one or more actions are performed based on the DLP scan of the file.

11. A non-transitory computer-readable medium comprising instructions that, when executed, cause one or more processors of a cloud-based system to perform steps of:
monitoring user traffic associated with one or more tenants of the cloud-based system, the traffic including actions performed in association with a file sharing and storage service;
responsive to a user accessing a file within the file sharing and storage service, performing a Data Loss Prevention (DLP) scan requirement analysis;
based on a result of the DLP scan requirement analysis, (i) performing a DLP scan of the file or (ii) bypassing a DLP scan of the file; and
performing one or more actions based on policy associated with the user and the file.

12. The non-transitory computer-readable medium of claim 11, wherein the DLP scan requirement analysis is based on stored file metadata and the action performed by the user on the file.

13. The non-transitory computer-readable medium of claim 11, wherein the DLP scan requirement analysis is based on stored file metadata, the file metadata including any of a hash of the file, a name of the file, an owner of the file, a label of the file, a classification of the file, dictionaries of the file, a policy time stamp, and file sharing information.

14. The non-transitory computer-readable medium of claim 13, wherein a DLP scan is performed on the file responsive to determining that the file has been changed.

15. The non-transitory computer-readable medium of claim 13, wherein a DLP scan is performed on the file responsive to determining that policy associated with the file has been changed.

16. The non-transitory computer-readable medium of claim 13, wherein a DLP scan is performed on the file responsive to determining that an owner of the file has changed.

17. The non-transitory computer-readable medium of claim 13, wherein a DLP scan is performed on the file responsive to determining that file sharing information of the file has changed.

18. The non-transitory computer-readable medium of claim 11, wherein responsive to the user creating a new file in the file sharing and storage service, the steps comprise:
performing a DLP scan of the file; and
storing original metadata of the file.

19. The non-transitory computer-readable medium of claim 18, wherein the DLP scan requirement analysis is based on the original metadata of the file and current metadata of the file.

20. The non-transitory computer-readable medium of claim 11, wherein the one or more actions are performed based on the DLP scan of the file.
